(19) United States
(12) Patent Application Publication
(10) Pub. No.: US 2008/0142143 A1
(43) Pub. Date: Jun. 19, 2008

(54) PNEUMATIC TIRE AND PRODUCTION METHOD OF THE SAME

(75) Inventor: Hiroo MATSUNAGA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 11/969,749

(22) Filed: Jan. 4, 2008

Related U.S. Application Data
(63) Continuation-in-part of application No. 10/502,015, filed on Jul. 20, 2004, now abandoned.

(30) Foreign Application Priority Data
Jan. 21, 2002 (JP) 2002-11444

(51) Int. Cl. B60C 15/00

(52) U.S. Cl. 152/539

(57) ABSTRACT

A pneumatic tire in which separation of a tread rubber and a side rubber from each other at an interface therebetween can be substantially prevented and separation of the side rubber and a side wall rubber from each other at an interface therebetween can also be substantially prevented. The pneumatic tire is structured such that the interface between the side rubber and the side wall rubber is provided, not at a side surface side of the tire, but at a outer peripheral side area (i.e., low distortion portion) thereof. As a result, bending deformation acting at the interface between the side rubber and the side wall rubber can be reduced, thereby separation of the side rubber and the side wall rubber from each other at the interface can be prevented.

### TECHNICAL FIELD

The present invention relates to a pneumatic tire including a side rubber provided between a tread rubber and a side wall rubber.

### RELATED ART

Examples of conventional pneumatic tires include a tire having a structure as shown in FIG. 2A.

In such a pneumatic tire 70, a side wall rubber 76 is press-attached to each of side portions of a carcass 78, and, in a sectional view in the widthwise direction of the tire, each outer end portion of the side wall rubber 76 in a radial direction of the tire is bent toward inner side in a widthwise direction of the tire.

A tread rubber 72 is press-attached, via a belt 79, to a tread side of the carcass 78, which is on the outer side of the carcass 78 in the radial direction of the tire. Each outer end portion of the tread rubber 72 in the widthwise direction of the tire is positioned on the outer side, in the radial direction of the tire, of each outer end portion (i.e., bent portion) of the side wall rubber 74 in the radial direction of the tire.

In other words, each outer end portion of the tread rubber 72 in the widthwise direction of the tire is disposed on each outer end portion (i.e., bent portion) of the side wall rubber 74 in the radial direction of the tire.

Further, a side rubber 74 is press-attached on the outer side, in the widthwise direction of the tire, of each tire-widthwise-direction outer end portion of the tread rubber 72. Physical properties or composition of the side rubber 74 is the same as or similar to that of the side wall rubber 76.

In a production method of the above-described pneumatic tire 70, initially, in first molding, an unvulcanized inner liner rubber (not shown) is set on a rotary drum (not shown), and a carcass 78 is press-attached to the inner liner rubber.

After that, a bead filler including a bead core is attached at each end of the carcass, and the ends of the carcass 78 in a widthwise direction of the drum are bent to the outer side in the radial direction of the tire, so as to mold bead sections.

Then, an unvulcanized side wall rubber 76 is press-attached to each of side portions of the carcass 78.

Subsequently, in second molding, the diameter of the rotary drum is expanded so that the carcass 78 is toroidally deformed. Thereafter, a belt 79 is press-attached to the carcass 78 from the outer side in the radial direction of the tire, and an unvulcanized tread rubber 72 integrated with an unvulcanized side rubber 74 at each end thereof is further press-attached to the belt 79 and the side wall rubber 76.

The tread rubber 72 and the side rubber 74 to be used are integrally extruded by a dual tuber (not shown) which is conventionally known.

The pneumatic tire 70 is produced by the above-described method.

In the above-described production method, since the tread rubber 72 and the side rubber 74 are press-attached from the outer side in the radial direction of the tire after the side wall rubber 76 has been press-attached, production process is relatively simplified. Therefore, this production method has great advantages in improved production efficiency and reduced production cost. Accordingly, this production method is generally used for producing the pneumatic tire 70.

In general, physical properties or composition of the tread rubber 72 is significantly different from that of the side rubber 74. However, since the tread rubber 72 and the side rubber 74 to be used are integrated by a dual tuber in this production method, durability of an interface therebetween is improved. Thus, this production method has another advantage that separation of the tread rubber 72 and the side rubber 74 from each other at the interface therebetween, which separation occurs due to the difference of physical properties or composition therebetween, is less likely to occur.

However, in a case that an interface between the side rubber 74 and the side wall rubber 76 is provided at a side surface side of the tire where bending deformation of the tire is relatively large to become high distortion portions while the vehicle is running, separation of the side rubber 74 and the side wall rubber 76 from each other at the interface therebetween may occur.

Such separation described above may not be avoided even when the side rubber 74 and the side wall rubber 76 have the same or similar physical properties or composition.

Thus, in view of the above facts, According to the present invention, a pneumatic tire is provided in which not only separation of the tread rubber and the side rubber from each other at the interface therebetween but also separation of the side rubber and the side wall rubber from each other at the interface therebetween can be prevented.

### SUMMARY

An exemplary embodiment of the present invention is pneumatic tire including a pair of right and left bead cores, and a carcass toroidally straddling the bead cores, said pneumatic tire comprising: a tread rubber which forms a tread section, the tread rubber being disposed on the outer side of the carcass in a radial direction of the tire; a side rubber which forms a portion of each shoulder section, the side rubber being attached to each outer end portion of the tread rubber in a widthwise direction of the tire; and a side wall rubber which forms each side wall section and a portion of each shoulder section, each side wall rubber being disposed on the outer side of the carcass in the widthwise direction of the tire, and each inner end portion of the side wall rubber in the widthwise direction of the tire being attached to each outer end portion of the side rubber in the widthwise direction of the tire. In a sectional view in the widthwise direction of the tire, an interface between the side rubber and the side wall rubber is provided within an area which is defined with two lines, one line is drawn from a point that is widthwise direction end of the tire surface contacting with the ground and extended perpendicular to the carcass surface under a condition that the tire is placed on the ground while having a regular inner pressure and being applied with a regular load according to standards such as JATMA, TRA or ETRTO, and the other line is drawn from a point on the tire surface that is defined to have an identical radial length with the tire widthwise direction end of the tread rubber and extended perpendicular to the carcass surface.

Next, the operation and effects of the pneumatic tire according to the above aspect will be described.

In the pneumatic tire according to the above aspect, a tread section is formed by a tread rubber, which is disposed on the outer side of a carcass in a radial direction of the tire. Further, a portion of each shoulder section is formed by a side rubber, the side rubber is attached to each outer end portion of the tread rubber in the widthwise direction of the tire. Furthermore, each side wall section and a portion of each shoulder section are formed by a side wall rubber, the side wall rubber is disposed on the outer side of the carcass in the widthwise direction of the tire, and each inner end portion of the side wall rubber in the widthwise direction of the tire is attached to each outer end portion of the side rubber in the widthwise direction of the tire.

According to the above aspect, an interface between the side rubber and the side wall rubber is provided, not at a side surface side of the tire, but at an outer peripheral side area of the tire. Note that the outer peripheral side area of the tire indicates, in a sectional view in the widthwise direction of the tire, such an area which is defined with two lines, one line is drawn from a point that is widthwise direction end of the tire surface contacting with the ground and extended perpendicular to the carcass surface under a condition that the tire is placed on the ground while having a regular inner pressure and being applied with a regular load according to standards such as JATMA, TRA or ETRTO, and the other line is drawn from a point on the tire surface that is defined to have an identical radial length with the tire widthwise direction end of the tread rubber and extended perpendicular to the carcass surface. The side surface side of the tire indicates an area which is defined to be positioned inner side in the radial direction of the tire with respect to the outer peripheral side area.

Here, while the vehicle is running, bending deformation of the tire is larger at the side surface sides of the tire than at the outer peripheral side area thereof. Namely, the side surface sides of the tire are high distortion portions.

Therefore, the pneumatic tire of the present invention is structured such that the interface between the side rubber and the side wall rubber is provided, not at the side surface side of the tire, but at the outer peripheral side area, i.e., low distortion portion. As a result, the bending deformation acting at the interface between the side rubber and the side wall rubber can be reduced, thereby separation of the side rubber and the side wall rubber from each other at the interface can be prevented. In other words, the interface between the side rubber and the side wall rubber is positioned at the outer peripheral side area of the tire, which area is a low distortion portion, so that separation of the side rubber and the side wall rubber from each other at the interface can be prevented.

In the above aspect, a difference of Shore hardness between the side rubber and the side wall rubber may be at 5 degrees or less. A possibility that the side rubber and the side wall rubber are separated from each other at the interface therebetween can be significantly lowered.

In the above aspect, the end of the tread rubber in the tire widthwise direction and the side rubber may be attached to the carcass. By attaching the end of the tread rubber in the tire widthwise direction and the side rubber to the carcass which is a frame member, deformation amount difference between the end of the tread rubber and the side rubber can become little when input load is applied from the ground surface to those parts. Thereby, a possibility that the side rubber and the tread rubber are separated from each other at the interface therebetween can be significantly lowered.

### BRIEF DESCRIPTION OF THE DRAWINGS

FIG. 1 is a partially sectional view of a pneumatic tire according to an embodiment of the present invention.

FIG. 2A is a partially sectional view of a pneumatic tire of Related art.

FIG. 2B is a partially sectional view of the pneumatic tire of an embodiment of the present invention.

### DESCRIPTION

Hereinafter, a pneumatic tire according to an embodiment of the present invention will be described with reference to the attached drawings.

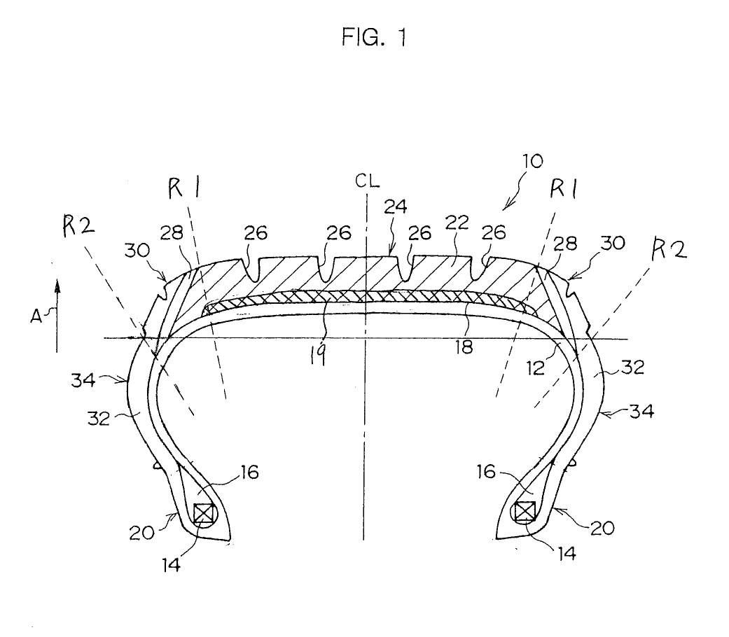

As shown in FIG. 1, a pneumatic tire 10 includes an inner liner rubber 12.

A pair of right and left bead cores 14 is disposed on the outer side of the inner liner rubber 12. The bead core 14 is composed of plural bead wires and included by a bead filler 16.

A carcass 18 of a toroidal shape straddles on the bead cores 14 and the bead fillers 16. Ends of the carcass 18 in the radial direction of the tire are bent substantially toward the outer side in the radial direction of the tire (i.e., toward the side indicated by Arrow A in FIG. 1) so as to respectively envelop the bead cores 14 and the bead fillers 16. In this way, bead sections 20 are formed.

A belt 19 is disposed on the outer side of the carcass 18 in the radial direction of the tire.

A tread rubber 22 (i.e., a hatched portion in FIG. 1) is attached on the outer side of the belt 19 in the radial direction of the tire. Shore hardness of the tread rubber 22 is 68, and the blend ratio thereof, of SBR/NR/BR(PHR), is 100/0/0.

A tread section 24 is formed by the tread rubber 22. Further, plural circumferential grooves 26 extending in the circumferential direction of the tire are formed on a surface of the tread section 24.

A side rubber 28 is attached to each outer end portion of the tread rubber 22 in the widthwise direction of the tire. Shore hardness of the side rubber 28 is 55, and the blend ratio thereof, of SBR/NR/BR(PHR), is 0/50/50. A portion of a shoulder section 30 is formed by the side rubber 28.

A side wall rubber 32 is press-attached to each of side portions of the carcass 18, which side portions are outer portions of the carcass 18 in the widthwise direction of the tire. Shore hardness of the side wall rubber 32 is 55, and the blend ratio thereof, of SBR/NR/BR(PHR), is 0/50/50. An inner end portion of the side wall rubber 32 in the widthwise direction of the tire is attached to an outer end portion of the side rubber 28 in the widthwise direction of the tire.

A side wall section 34 and a portion of the shoulder section 30 are formed by the side wall rubber 32 on each side of the tire.

In the present embodiment, an interface between the side rubber 28 and the side wall rubber 32 is provided, in a sectional view in the widthwise direction of the tire, within an area which is defined with two lines R1 and R2. One line R1 is defined as being drawn from a point that is widthwise direction end of the tire surface which contacts with the ground and extended perpendicular to the carcass surface under a condition that the tire is placed on the ground while having a regular inner pressure and being applied with a regular load according to standards such as JATMA, TRA or ETRTO. The other line R2 is defined as being drawn from a point on the tire surface that is defined to have an identical radial length with the tire widthwise direction end of the tread rubber 22 and extended perpendicular to the carcass surface. Further, each end of the tread rubber 22 in the tire widthwise direction and the side rubber 28 are attached to the carcass 18.

Next, the operation and effects of the pneumatic tire 10 will be described.

In the pneumatic tire 10 of the present invention, an interface between the side rubber 28 and the side wall rubber 32 is provided, not at a side surface side of the tire 10, but at an outer peripheral side area thereof. Note that the outer peripheral side area is defined, in a sectional view in the widthwise direction of the tire 10, with two lines R1 and R2. One line R1 is drawn from a point that is widthwise direction end of the tire surface which contacts with the ground and extended perpendicular to the carcass surface under a condition that the tire 10 is placed on the ground while having a regular inner pressure and being applied with a regular load according to standards such as JATMA, TRA or ETRTO and the other line R2 is drawn from a point on the tire surface that is defined to have an identical radial length with the tire widthwise direction end of the tread rubber 22 and extended perpendicular to the carcass surface. The side surface side of the tire indicates an area which is defined to be positioned inner side in the radial direction of the tire with respect to the outer peripheral side area.

Here, while the vehicle is running, bending deformation of the tire is larger at the side surface sides of the tire than at the outer peripheral side areas thereof. Namely, the side surface sides of the tire are high distortion portions.

Therefore, the pneumatic tire 10 of the present invention is structured such that the interface between the side rubber 28 and the side wall rubber 32 is provided, not at the side surface side of the tire, but at the outer peripheral side area (i.e., low distortion portion) thereof. As a result, the bending deformation acting at the interface between the side rubber 28 and the side wall rubber 32 can be reduced, and thereby separation of the side rubber 28 and the side wall rubber 32 from each other at the interface can be prevented.

In other words, the interface between the side rubber 28 and the side wall rubber 32 is positioned at the outer peripheral side area of the tire, which area is a low distortion portion, so that separation of the side rubber 28 and the side wall rubber 32 from each other at the interface can be prevented.

Further, since Shore hardness of the side rubber 28 and the side wall rubber 32 are same each other, a possibility that the side rubber 28 and the side wall rubber 32 are separated from each other at the interface therebetween can be significantly lowered.

Additionally, since the end of the tread rubber 22 in the tire widthwise direction and the side rubber 28 are attached to the carcass 18, deformation amount difference between the end of the tread rubber 22 and the side rubber 28 can become little when input load is applied from the ground surface to those parts. Thereby, a possibility that the side rubber 28 and the tread rubber 22 are separated from each other at the interface therebetween can be significantly lowered.

As described above, in the pneumatic tire 10 of the exemplary embodiment, separation of the tread rubber 22 and the side rubber 28 from each other at the interface therebetween can be prevented, and separation of the side rubber 28 and the side wall rubber 32 from each other at the interface therebetween can also be prevented.

### TEST EXAMPLE

Next, a durability test for examining interface separation generation was conducted by using the pneumatic tires of the present invention and other tires.

The size of the tires used for the test was PCR225/45R17. The tires of this size were respectively assembled with rims each having a rim width of 8 J. Each internal pressure was set to 200 KPa.

These tires assembled with the rims were respectively mounted to domestic midsize sedans. After driving with a load, which is equivalent to two occupants, on roads whose road surface conditions were set so as to include 30% of general road, 50% of highway and 20% of rough road, interface separation generation was visually checked by an operator.

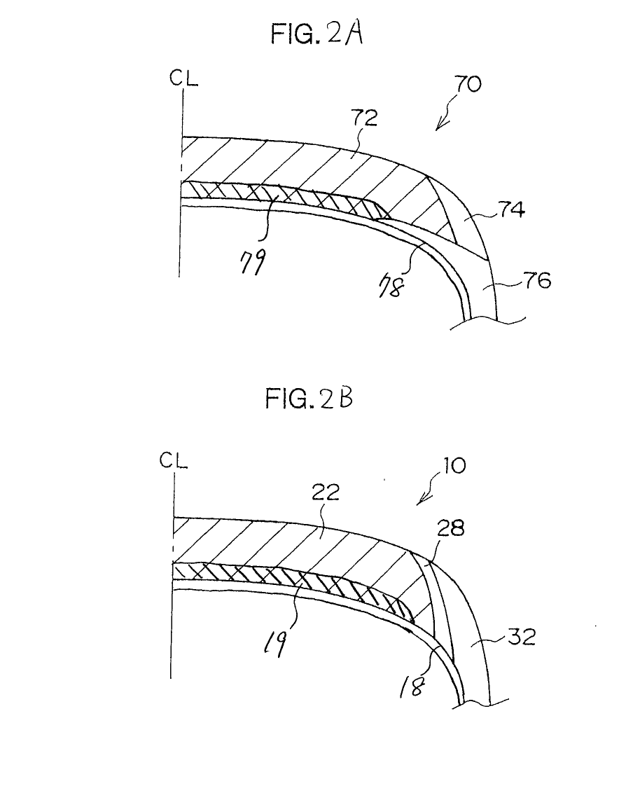

Related art is the pneumatic tire 70 in which, as described in the above “Related Art” section (see FIG. 2A), the side rubber 74 is attached to each outer end portion of the tread rubber 72 in the widthwise direction of the tire, and each outer end portion of the side wall rubber 76 in the radial direction of the tire is positioned at the lower side (i.e., the inner side in the radial direction of the tire) of the tread rubber 72 and the side rubber 74.

Thus, Related art has a dual-tread structure, in which the tread rubber 72 and the side rubber 74 are integrally molded. In Related art, the side wall rubber 76 is first attached to each of the side portions of the carcass 78, and then the side rubber 74 integrated with the tread rubber 72 at each end thereof is attached to the side wall rubber 76 at the outer side of the carcass 78 in the radial direction of the tire. The interface between the side rubber 74 and the side wall rubber 76 is provided to extend into the side surface side.

As shown in Table 2 below, Shore hardness of the tread rubber 72 is 68, and the blend ratio thereof, of SBR/NR/BR(PHR), is 100/0/0.

Further, Shore hardness of the side wall rubber 76 and the side rubber 74 is 55, and the blend ratio thereof, of SBR/NR/BR(PHR), is 0/50/50.

The pneumatic tire 10 according to the exemplary embodiment of the invention is, as shown in FIGS. 1 and 2B, the side rubber 28 is attached to each outer end portion of the tread rubber 22 in the widthwise direction of the tire, and each inner end portion of the side wall rubber 32 in the widthwise direction of the tire is attached to the outer end portion of the side rubber 28 in the widthwise direction of the tire.

Thus, the pneumatic tire 10 has a dual-tread structure, in which the tread rubber 22 and the side rubber 28 are integrally molded. The side rubber 28 integrated with the tread rubber 22 at each end thereof is attached on the outer side of the carcass 18 in the radial direction of the tire, and then the side wall rubber 32 is attached to each of side portions of the carcass 18. The interface between the side rubber 28 and the side wall rubber 32 is provided within the outer peripheral side area. Additionally, the each end of the tread rubber 22 and the side rubber 28 are attached to the carcass 18.

As shown in Table 2 below, Shore hardness of the tread rubber 22 is 68, and the blend ratio thereof, of SBR/NR/BR(PHR), is 100/0/0.

Further, Shore hardness of the side wall rubber 32 and the side rubber 28 is 55, and the blend ratio thereof, of SBR/NR/BR(PHR), is 0/50/50.

Comparative Example is a pneumatic tire having similar tread structure to that of the pneumatic tire 10 noted above however, the interface between the side rubber and the side wall rubber is provided at the outer peripheral side area and extends into the side surface side.

TABLE 1

| | | Present | Comparative |
|---|---|---|---|
| | Related art | Example | Example |
| Tread structure | Dual-tread | Dual-tread | Dual-tread |
| Interface between | Provided at side | Provided | Provided at side |
| side rubber and | surface side | within outer | surface side |
| side wall rubber | | peripheral side | |
| | | area only | |
| Separation | Generated at | No separation | Generated at |
| generation | interface between | was generated | interface between |
| (Durability test) | side rubber and | till wear rate | side rubber and |
| | side wall rubber | reached 100% | side wall rubber |
| | when wear rate | | when wear rate |
| | was 75% | | was 80% |

TABLE 2

| | Tread | Side wall | Side |
|---|---|---|---|
| | rubber | rubber | rubber |
| HD (Shore hardness) | 68 | 55 | 55 |
| SBR/NR/BR(PHR) | 100/0/0 | 0/50/50 | 0/50/50 |

In Related art, separations were generated at the interface between the side rubber 74 and the side wall rubber 76 when the wear rate was 75%.

In Comparative Example, separations were generated at the interface between the side rubber and the side wall rubber when the wear rate was 80%.

In the present example, no separation was generated even when the wear rate was 100%.

As shown above, no separation occurred at the interface between the tread rubber 22 and the side rubber 28 as well as the interface between the side rubber 28 and the side wall rubber 32 even when the wear rate is 100% in the pneumatic tire of the present invention.

### INDUSTRIAL APPLICABILITY

As described above, the pneumatic tire according to the present invention is preferably applied to vehicles such as a passenger car, and is suitable for a case where separation of the tread rubber and the side rubber from each other at the interface therebetween is to be prevented and separation of the side rubber and the side wall rubber from each other at the interface therebetween is also to be prevented.

1. A pneumatic tire comprising a pair of right and left bead cores, and a carcass toroidally straddling the bead cores, said pneumatic tire further comprising:
a tread rubber which forms a tread section, the tread rubber being disposed on the outer side of the carcass in a radial direction of the tire;
a side rubber which forms a portion of each shoulder section, the side rubber being attached to each outer end portion of the tread rubber in a widthwise direction of the tire; and
a side wall rubber which forms each side wall section and a portion of each shoulder section, each side wall rubber being disposed on the outer side of the carcass in the widthwise direction of the tire, and each inner end portion of the side wall rubber in the widthwise direction of the tire being attached to each outer end portion of the side rubber in the widthwise direction of the tire wherein;
in a sectional view in the widthwise direction of the tire, an interface between the side rubber and the side wall rubber is provided within an area being defined with two lines, one line being drawn from a point that is widthwise direction end of the tire surface contacting with the ground and extended perpendicular to the carcass surface under a condition that the tire is placed on the ground while having a regular inner pressure and being applied with a regular load according to standards such as JATMA, TRA or ETRTO, and the other line being drawn from a point on the tire surface that is defined to have an identical radial length with the tire widthwise direction end of the tread rubber and extended perpendicular to the carcass surface.

2. A pneumatic tire according to claim 1, wherein a Shore hardness difference between the side rubber and the tread rubber is five degrees or less.

3. A pneumatic tire according to claim 1, wherein the end of the tread rubber in the tire widthwise direction and the side rubber are attached to the carcass.
